(19) United States
(12) Patent Application Publication
(10) Pub. No.: US 2013/0243486 A1
(43) Pub. Date: Sep. 19, 2013

(54) DISCHARGE WIRE ANCHORING MECHANISM, CHARGER USING SAME, AND IMAGE FORMING APPARATUS USING SAME

(71) Applicant: Toshiya SATOH, Kanagawa (JP)

(72) Inventor: Toshiya SATOH, Kanagawa (JP)

(21) Appl. No.: 13/768,091

(22) Filed: Feb. 15, 2013

(30) Foreign Application Priority Data
Mar. 19, 2012 (JP) 2012-061971

(51) Int. Cl. G03G 15/02

(52) U.S. Cl. CPC G03G 15/0208
USPC 399/174

(57) ABSTRACT

A discharge wire anchoring mechanism that is includable in an image forming apparatus together with an image carrier and a charger including at least one replaceable discharge wire to uniformly charge a surface of the image carrier. The discharge wire anchoring mechanism includes a wire holder to retain the at least one discharge wire with tension in preparation of anchoring the at least one discharge wire and separating from the at least one discharge wire after the at least one discharge wire is anchored to the charger.

### CROSS-REFERENCE TO RELATED APPLICATION

This patent application is based on and claims priority pursuant to 35 U.S.C. §119 to Japanese Patent Application No. 2012-061971, filed on Mar. 19, 2012, in the Japan Patent Office, the entire disclosure of which is hereby incorporated by reference herein.

### BACKGROUND OF THE INVENTION

1. Field of the Invention

Embodiments of the present invention relate to a discharge wire anchoring mechanism that is includable to an electrophotographic image forming apparatus including a charging unit, such as a copier, a printer, and a facsimile machine.

2. Description of the Related Art

Recently, a decrease in running cost, specifically the cost for printing one sheet (cost per printing, hereinafter “CPP”) for an image forming apparatus such as a printer has been processed. Extending use lives of expendable parts and components used for an electrophotographic image forming apparatus and enhancing easy maintenance of the apparatus contribute to a reduction of operational expense, which is advantageous for a reduction in CPP.

A charging unit used in an electrophotographic image forming apparatus charges a surface of a photoconductor with corona discharge generated by applying high voltage to a discharge wire. At this time, the corona discharge ionizes floating toner additives in the apparatus to be attracted to the discharge wire.

The attached material enhances to increase resistivity on the surface of the discharge wire, which can easily cause contamination on the discharge wire. This can result in failure of normal discharging and cause errors such as halftone nonuniformity in image forming. Therefore, regular replacement of discharge wires is mandatory.

A discharge wire is a metallic wire and very thin like a thread. The discharge wire is generally a tungsten or a metal plated tungsten and has approximately 60 μm in thickness. Therefore, it is usually difficult to handle discharge wire without damaging or bending the wire.

Further, if the surface of the discharge wire is damaged, abnormal discharge occurs from the portion locally, and can result in occurrence of black streaks on an image formed on the surface of a photoconductor. To prevent this disadvantage, not only regular replacement of discharge wires but also damage prevention care during transportation or storage of the discharge wires are required.

Further, demands for rapid progress and high productivity are increasing in the market for recent printers and copiers. Since such an image forming apparatus has a photoconductor with high linear speed, it is difficult to apply a preferable charging potential to the surface of a photoconductor with one discharge wire. Therefore, to obtain a normal image, a charging unit having a bundle of multiple discharge wires is necessary to be included in a printer or a copier. For example, some types of high-specification printer that can provide high-speed printing operation include three discharge wires.

Japanese Patent Application Publication No. H09-101660 (JP-H09-101660-A) discloses an image forming apparatus that includes a toner hopper that can be pulled out from and returned to the main body of the image forming apparatus and a wire cleaning movable member to clean the wire of the charging unit of an image carrier in synchronization of the pulling-out and returning movement of the toner hopper.

Further, Japanese Patent Application Publication No. H11-212334 (JP-H11-212334-A) discloses a discharge wire of a corona discharger for replacement of the discharge wire. Furthermore, Japanese Patent Application Publication No. H10-097120 (JP-H10-097120-A) discloses a technique in which a fixing member can be reused by exchanging only a fixing pin in an electric discharge wire fixing mechanism for a corona discharger.

However, in any of Japanese Patent Application Publication Nos. JP-H09-101660-A, JP-H11-212334-A, and JP-H10-097120-A, it is likely to damage the surface of a wire by contacting other parts or components or by bending the discharge wire when replacing the discharge wires. In addition, these techniques are not for improving operability for replacing or anchoring fine and fragile discharge wires in small space in a charger. This possibility of damaging discharge wires in small space is more obvious, for example, in the above-described high-specification printer with multiple discharge wires.

### SUMMARY OF THE INVENTION

The present invention describes a novel discharge wire anchoring mechanism that is includable in an image forming apparatus together with an image carrier and a charger including at least one replaceable discharge wire to uniformly charge a surface of the image carrier. The novel discharge wire anchoring mechanism includes a wire holder to retain the at least one discharge wire with tension in preparation of anchoring the at least one discharge wire and separating from the at least one discharge wire after the at least one discharge wire is anchored to the charger.

The wire holder may be made of resin material.

The at least one discharge wire may be arranged to have a substantially same positional relation in the charger as a corresponding hook position of the charger.

The wire holder may be flexible and elastic, and may include a plate-shaped base member, and wire retaining members integrally formed with the plate-shaped base member, the wire retaining members disposed at both ends of the plate-shaped base member in a longitudinal direction thereof to retain both ends of the at least one discharge wire.

The wire holder may be separated from the at least one discharge wire in a state in which the wire retaining members are warped toward the center of the wire holder in the longitudinal direction of the plate-shaped base member.

The wire retaining members may be disposed vertical to the longitudinal direction of the plate-shaped base member at both ends of the plate-shaped base member. Each of the wire retaining members may include an extended portion extending outward from the surface of the plate-shaped base member toward a portion to which the at least one discharge wire is anchored, the wire retaining members retaining retain the end of the at least one discharge wire, and a wire holder handle extending from either end of the plate-shaped base member outwardly to form an arc shape.

The extended portion may include at least one notch through which each of the at least one discharge wire passes. A width of each of the at least one notch may be greater than the diameter of each of the at least one discharge wire and smaller than the cross-sectional diameter of each of the end of the at least one discharge wire.

The above-described discharge wire anchoring mechanism may further include a latching member to latch an end of the at least one discharge wire to a hook of the charger.

Further, a novel charger, which is includable in an image forming apparatus for uniformly charging a surface of an image carrier to form an image thereon, includes at least one discharge wire to be replaceable with a new one using the discharge wire anchoring mechanism. The discharge wire anchoring mechanism may include a wire holder to retain the at least one discharge wire with tension. The at least one discharge wire is anchored to the charger with the at least one discharge wire retained to the wire holder and then the wire holder detaches the at least one discharge wire.

The discharge wire may be either one of a tungsten wire and a metal plated tungsten wire.

The above-described charger may further include a hook to which an end of the at least one discharge wire is latched.

Further, a novel image forming apparatus includes an image carrier, a charger disposed detachably attachable to the image forming apparatus to uniformly charge a surface of the image carrier to form an image thereon and include at least one discharge wire to be replaceable with a new one using a discharge wire anchoring mechanism, and a discharge wire anchoring mechanism comprising a wire holder to retain the at least one discharge wire with tension in preparation of anchoring the at least one discharge wire and separating from the at least one discharge wire after the at least one discharge wire is anchored to the charger. The discharge wire anchoring mechanism includes a wire holder to retain the at least one discharge wire with tension. The at least one discharge wire is anchored to the charger with the at least one discharge wire retained to the wire holder and then the wire holder detaches the at least one discharge wire.

### BRIEF DESCRIPTION OF THE SEVERAL VIEWS OF THE DRAWINGS

A more complete appreciation of the invention and many of the advantages thereof will be obtained as the same becomes better understood by reference to the following detailed description when considered in connection with the accompanying drawings, wherein:

FIG. 1 is a schematic cross-sectional view illustrating an image forming apparatus including a discharge wire anchoring mechanism according to an embodiment of the present invention;

FIG. 2 is a schematic perspective view illustrating a charger to which a discharge wire according to an embodiment of the present invention is anchored;

FIG. 3A is a schematic perspective view illustrating the discharge wire anchoring mechanism according to an embodiment of the present invention;

FIG. 3B is a schematic diagram illustrating a right side of the discharge wire anchoring mechanism according to an embodiment of the present invention;

FIG. 3C is a schematic diagram illustrating a bottom of the discharge wire anchoring mechanism according to an embodiment of the present invention;

FIG. 3D is a schematic diagram illustrating a front of the discharge wire anchoring mechanism according to an embodiment of the present invention;

FIG. 4 is a schematic diagram illustrating a relation of a discharge wire retaining position (or a discharge wire retainer position) of a wire holder of the discharge wire anchoring mechanism according to an embodiment of the present invention and a hook position of the charger;

FIG. 5 is a schematic perspective view illustrating how to anchor the discharge wire to the charger;

FIG. 6 is a schematic perspective view illustrating how to anchor one end of the discharge wire to the charger and remove the wire holder from the discharge wire; and

FIG. 7 is a schematic perspective view illustrating how to anchor the other end of the discharge wire to the charger and remove the wire holder from the discharge wire.

### DETAILED DESCRIPTION OF THE INVENTION

It will be understood that if an element or layer is referred to as being “on”, “against”, “connected to” or “coupled to” another element or layer, then it can be directly on, against, connected or coupled to the other element or layer, or intervening elements or layers may be present. In contrast, if an element is referred to as being “directly on”, “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath”, “below”, “lower”, “above”, “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

Although the terms first, second, etc. may be used herein to describe various elements, components, regions, layers and/or sections, it should be understood that these elements, components, regions, layer and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Descriptions are given, with reference to the accompanying drawings, of examples, exemplary embodiments, modification of exemplary embodiments, etc., of an image forming apparatus according to the present invention. Elements having the same functions and shapes are denoted by the same reference numerals throughout the specification and redundant descriptions are omitted. Elements that do not require descriptions may be omitted from the drawings as a matter of convenience. Reference numerals of elements extracted from the patent publications are in parentheses so as to be distinguished from those of exemplary embodiments of the present invention.

The present invention is applicable to any image forming apparatus, and is implemented in the most effective manner in an electrophotographic image forming apparatus.

In describing preferred embodiments illustrated in the drawings, specific terminology is employed for the sake of clarity. However, the disclosure of the present invention is not intended to be limited to the specific terminology so selected and it is to be understood that each specific element includes all technical equivalents that have the same function, operate in a similar manner, and achieve a similar result.

Referring now to the drawings, wherein like reference numerals designate identical or corresponding parts throughout the several views, preferred embodiments of the present invention are described.

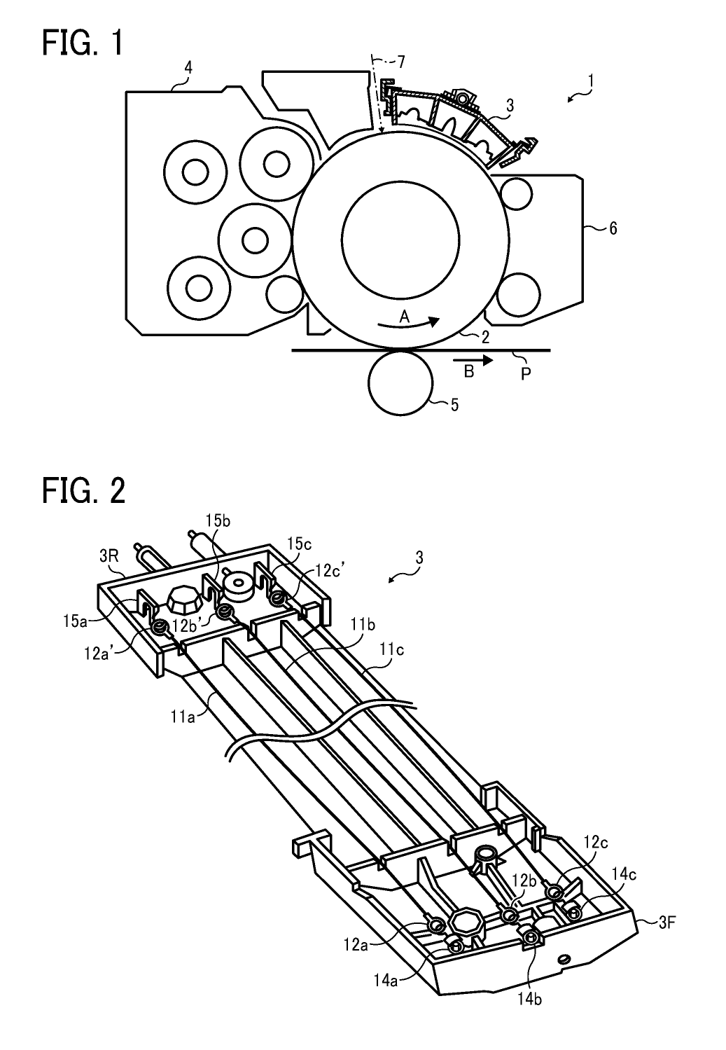

Referring to FIG. 1, a description is given of a configuration of an image forming apparatus 1 that can include a discharge wire anchoring mechanism 100 according to an embodiment of the present invention and the replacement of discharge wires used for the discharge wire anchoring mechanism 100.

FIG. 1 illustrates a schematic configuration of an image forming apparatus 1 applicable to the discharge wire anchoring mechanism 100 according to an embodiment of the present invention.

The image forming apparatus 1 is an electrophotographic image forming apparatus using photoconductors and dry developer. Specifically, the image forming apparatus 1 includes a photoconductor 2, a charging unit 3 to uniformly charge the surface of the photoconductor 2, a development unit 4, a transfer unit including a transfer belt and a transfer roller, and a cleaning unit 6 to remove toner remaining on the surface of the photoconductor 2 after a transfer and separation process.

The photoconductor 2 serves as an image carrier and rotates in a counterclockwise as indicated by arrow A in FIG. 1.

The surface of the photoconductor 2 is uniformly charged by corona discharge from the charging unit 3 and a grid electrode with applied voltage. In an exposure process, an optical image based on an original document is exposed on the surface of the photoconductor 2 or a laser scanner (not illustrated) emits a laser light beam 7 for optically writing an electrostatic latent image on the surface of the photoconductor 2. Thereafter, the development unit 4 supplies toner to the surface of the electrostatic latent image to develop it into a visible toner image.

The toner image formed on the surface of the photoconductor 2 is transferred onto a recording paper P in the transfer and separation process performed by the transfer unit 5. The recording paper P is further conveyed in a direction indicated by arrow B in FIG. 1 for further image forming operation such as a fixing operation.

However, some amount (%) of toner remains on the surface of the photoconductor 2 without being transferred onto the recording paper P. The toner remaining on the surface of the photoconductor 2, which is hereinafter referred to as a residual toner, is removed and cleaned by the cleaning unit 6.

It is to be noted that a description regarding operations and functions of the other devices and units, such as a fixing unit and a sheet feeding unit that are included in the image forming apparatus 1 is omitted in the embodiment of the present invention.

Referring to FIG. 2, a description is given to the detailed configuration of the charging unit 3.

The charging unit 3 serves as a charger that charges the surface of a photoconductor by utilizing corona discharge that generates by applying high voltage to a discharge wire. According to the charging unit 3 of FIG. 2, a front part illustrated at the lower right of FIG. 2 3 is referred to as a unit front part 3F and a rear part at the upper left is referred to as a unit rear part 3R.

In this embodiment, the charging unit 3 is attachable to and detachable from the front side (an operator side) of the image forming apparatus 1 when an operator replaces discharge wires. However, the portion for attaching and detaching the charging unit 3 is not limited thereto, and the charging unit 3 can be detachably attachable to top of the image forming apparatus 1 for replacing discharge wires.

In this embodiment, the charging unit 3 includes three discharge wires 11a through 11c that include terminals 12a through 12c and 12a′ through 12c′ at both ends of the discharge wires 11a through 11c, respectively. The terminals 12a through 12c and 12a′ through 12c′ serve as latching members. The charging unit 3 further includes hook positions 13a through 13c, front hooks 14a through 14c, and rear hooks 15a through 15c.

The terminals 12a through 12c and 12a′ through 12c′ at both ends of the discharge wires 11a through 11c are hooked or latched to the front hooks 14a through 14c and the rear hooks 15a through 15c, respectively, so that the discharge wires 11a through 11c are anchored to the charging unit 3. The hook positions 13a through 13c are the positions at which the front hooks 14a through 14c and the rear hooks 15a through 15c are disposed on the charging unit 3. The front hooks 14a through 14c are elastic members such as spring.

The discharge wires 11a through 11c include metallic wires that are very thin like a thread. For example, the metallic wires generally include a tungsten or a metal plated tungsten and have approximately 60 μm in thickness.

It is to be noted that the image forming apparatus 1 according to an embodiment of the present invention includes three discharge wires, the discharge wires 11a through 11c. However, the number of discharge wires is not limited thereto. It is also to be noted that both ends of the discharge wires 11a through 11c according to an embodiment of the present invention have a ring-shaped terminal but the shape of the terminal is not limited thereto.

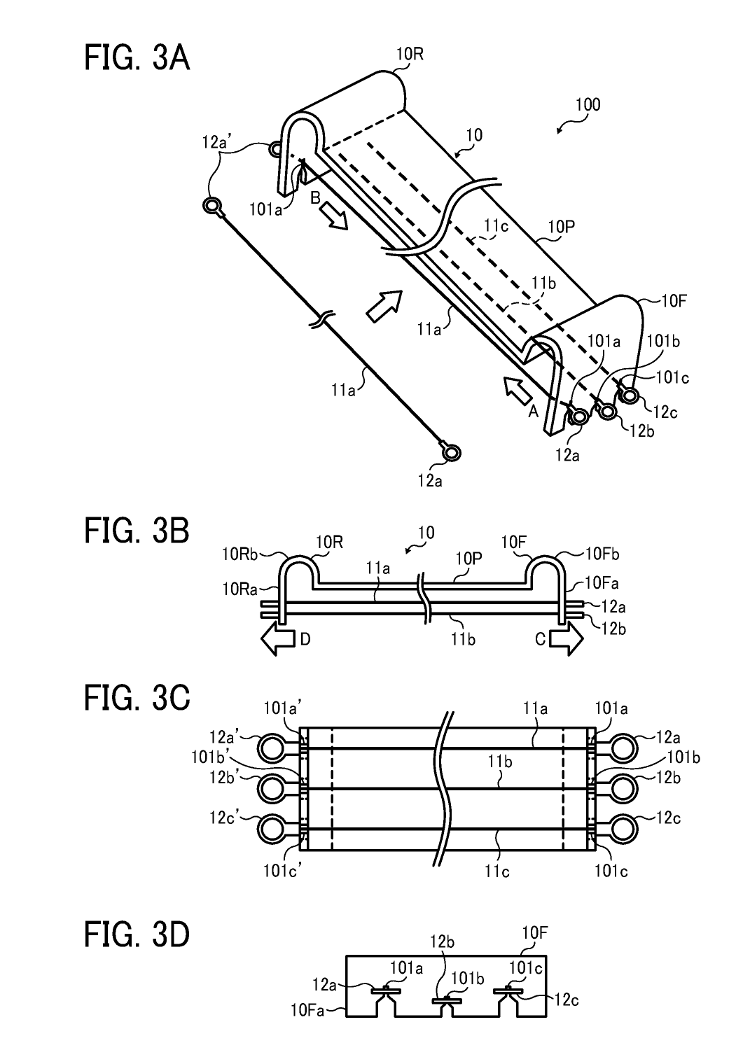

Referring to FIGS. 3A through 3D, a description is given of the discharge wire anchoring mechanism 100 according to an embodiment of the present invention.

The discharge wire anchoring mechanism 100 includes a wire holder and a discharge wire 11 as a replaceable part. The discharge wire 11 corresponds to any or all of the discharge wires 11a through 11c.

The wire holder 10 holds the discharge wire 11 in a tensioned condition to anchor the discharge wire 11 to the charging unit 3

The wire holder 10 is a flexible and elastic member and preferably made of resin material, for example. The wire holder 10 includes a substantially rectangular-shaped plate member 10P (i.e., a base member) and wire retaining members integrally formed with the plate member 10P. The wire retaining members are disposed at both ends of the plate member 10P in a longitudinal direction of the plate member 10. In this embodiment, each of the wire retaining members has a substantially U-shaped structure in which one side for retaining one end of the discharge wire 11 has at least one opening or slit and the other side for retaining the other end of the discharge wire 11 has no opening or slit and is integrated with the plate member 10P.

The wire retaining members are disposed vertical to the longitudinal axis of the plate member 10P. One side of the U shape of the wire retaining member is fixedly joined or united with the plate member 10P and the other side or opposed side extends outward from and beyond the surface of the plate member 10P toward a portion to which the at least one discharge wire is anchored and longer than the joined side thereof. When anchoring the discharge wire 11 to the charging unit 3 using the wire holder 10, a portion that faces the unit front part 3F of the charging unit 3 is referred to as a front part wire retaining member 10F and another portion that faces the unit rear part 3R is referred to as a rear part wire retaining member 10R.

In addition, a plurality of slit-shaped notches 101 are formed on an extended portion (i.e., extended wire retaining portions 10Fa and 10Ra) of the wire retaining members 10F and 10R to pass the discharge wires 11 therethrough. The slit-shaped notches 101 are provided according to the number of discharge wires 11 to be set. The width of the slit-shaped notch 101 is greater than the diameter of each of the discharge wires 11 and smaller than the cross-sectional diameter of each of the terminals 12a through 12c of the discharge wires 11a through 11c.

In this embodiment, slit-shaped notches 101a, 101b, and 101c are provided for the discharge wires 11a, 11b, and 11c, respectively.

According to the above-described configuration, to pass the discharge wires 11a through 11c through the slit-shaped notches 101a through 101c, respectively, the extended portions 10Fb and 10Rb of the wire retaining members 10F and 10R are warped toward the center of the wire holder 10 in the longitudinal direction of the wire holder 10. Specifically, the extended portion 10Fa of the wire retaining member 10F is warped in a direction indicated by arrow A in FIG. 3A and the extended portion 10Ra of the wire retaining member 10R is warped in a direction indicated by arrow B in FIG. 3A. By so doing, the terminals 12a through 12c and 12a′ through 12c′ of the discharge wires 11a through 11c, respectively, are hooked or anchored to the corresponding slit-shaped notches 101a through 101c, by which the discharge wires 11a through 11c are tensioned by elastic forces of the wire holder 10, which is a force exerted by the extended portions 10Fb and 10Rb of the wire retaining members 10F and 10R to rebound to their original positions as indicated by arrows C and D, respectively, in FIG. 3B. Accordingly, the discharge wires 11a through 11c are retained by the wire holder 10.

In this embodiment, for anchoring these three discharge wires 11a through 11c without contacting each other, the width of the wire holder 10 in a lateral direction or in a direction perpendicular to the longitudinal direction of the wire holder 10 is arranged to have sufficient space between the slit-shaped notches 101a through 101c on both the wire retaining members 10F and 10R. However, the width between the slit-shaped notches on the wire retaining members 10F and 10R is not limited thereto and may be changed according to the number of the discharge wires 11 to be anchored.

Further, as described above, the closed side of the U-shaped portion of the wire retaining members 10F and 10R extends from either end of the plate member 10P outwardly to form an arc shape. For example, an operator or a checker can grab the wire holder 10 at these arc-shaped extended portions 10Fb and 10Rb of the wire retaining members 10F and 10R when replacing the discharge wires 11. The arc-shaped extended portions 10Fb and 10Rb serve as wire holder handles.

In this embodiment, the wire retaining members 10F and 10R have a U-shaped structure. However, the shape is not limited thereto as long as the discharge wires 11 can be held and supported. For example, the wire retaining members 10F and 10R can include an extended portion having a horizontal U-shaped structure or a V-shaped structure.

According to the above description, each of the discharge wires 11 is anchored to the wire holder 10 by being passed between both ends of the wire holder 10 in the longitudinal direction with tension. Therefore, it is not likely that the discharge wires 11 are damaged by contacting each other or being bent. Further, the discharge wires 11 are not damaged even in transportation or storage when the discharge wires 11 are packed in a box while the discharge wires 11 are anchored to the wire holder 10 correctly.

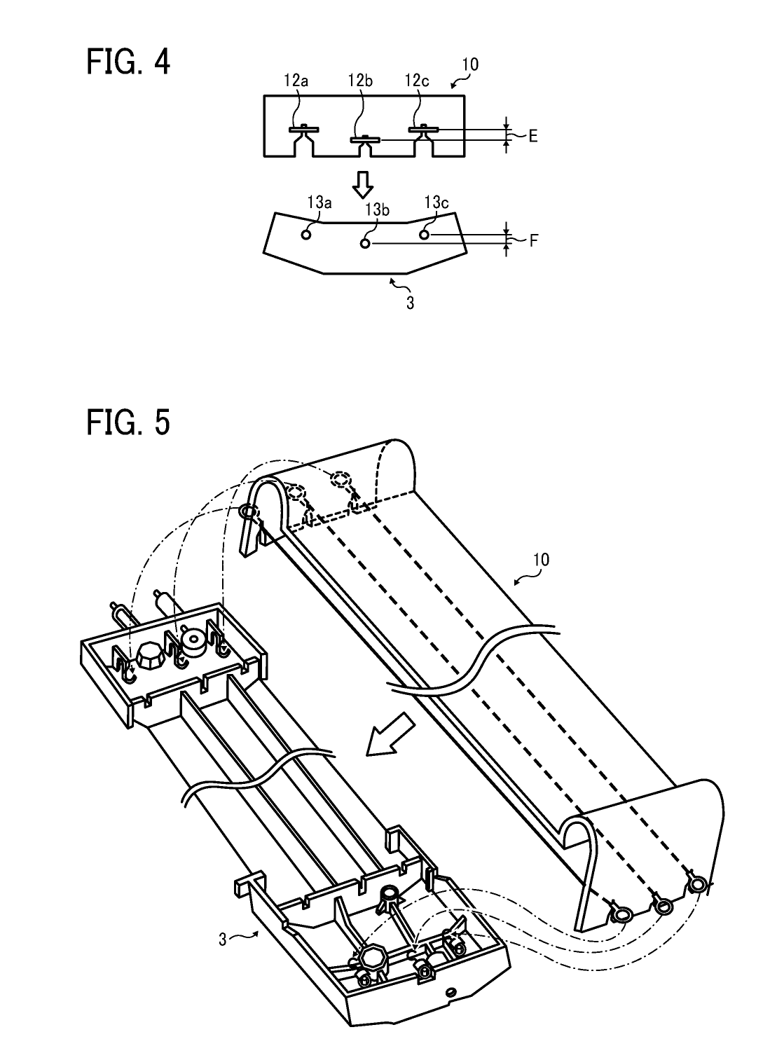

Further, since the hook positions 13a through 13c provided on the charging unit 3 for hooking the discharge wires 11 in the charging unit 3 are aligned at the same intervals from the photoconductor 2, the hook positions 13a through 13c are arranged along an arc shape as illustrated in FIG. 4. Therefore, when anchoring the discharge wires 11 using the wire holder 10, it is necessary to pass the terminals 12a through 12c of the discharge wires 11a through 11c to the hook positions 13a through 13c of the coronal charging unit 3 easily.

Accordingly, the discharge wire 11 of the wire holder 10 are arranged to have a substantially same positional relation as the hook positions 13a through 13c of the charging unit 3. Specifically, the substantially same positional relation is, for example, a relation that a distance E between the position for retaining the terminal 12b of the discharge wire 11b and the position for retaining the terminal 12c of the discharge wire 11c on the wire holder 10 and a distance F between the position of the hook positions 13b and the hook position 13c are same, as illustrated in FIG. 4.

Next, referring to FIGS. 5 through 7, a description is given of how to anchor or replace the discharge wire 11 in the charging unit 3. Since used discharge wires cannot be recycled, they are scrapped after being detached from the charging unit 3. Therefore, the used discharge wires can be removed by using a pin set and without using e a jig for damage protection, thereby removing the used discharge wires easily.

As described above, the wire holder 10 is used for anchoring the discharge wires 11 to the charging unit 3. Specifically, the terminal 12 of the discharge wire 11 is hooked (latched) to the hook position 13 of the charging unit 3 with the discharge wire 11 anchored to the wire holder 10, as illustrated in FIG. 5.

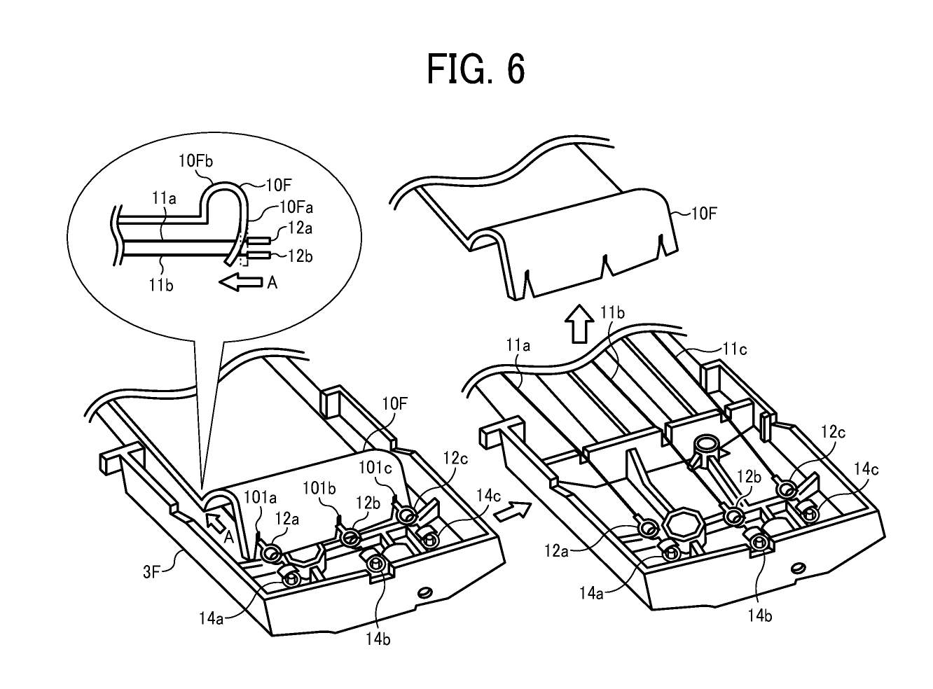

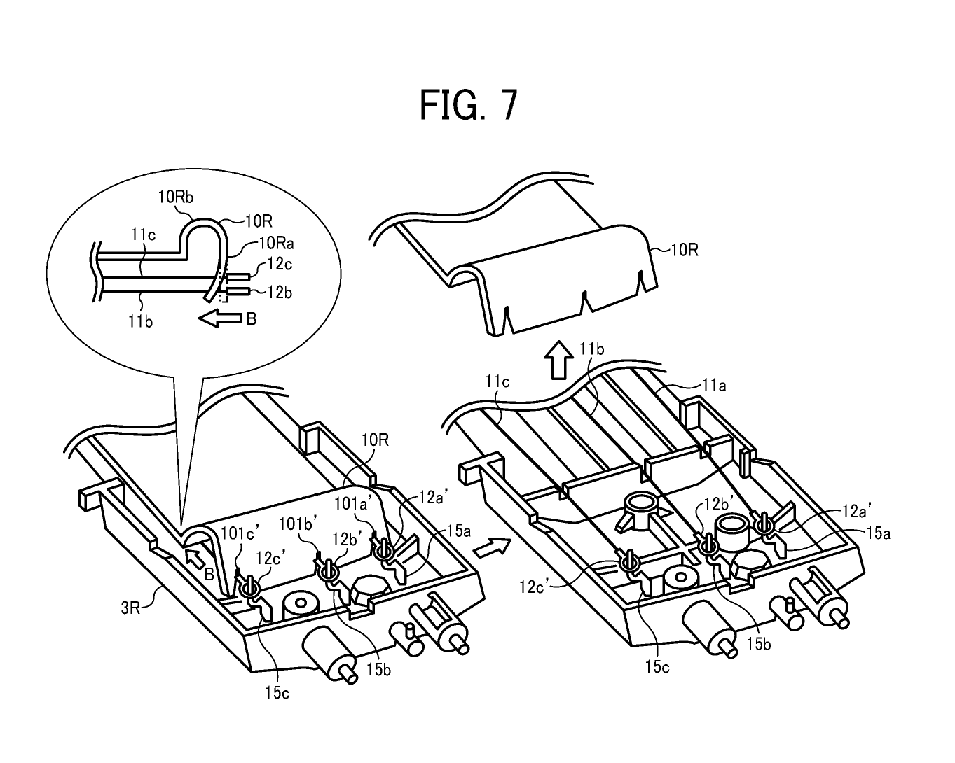

As illustrated in FIG. 6, when latching the terminal 12 of the discharge wire 11 to the hook position 13 of the charging unit 3, the terminals 12a through 12c that are provided at one end of the discharge wires 11a through 11c, respectively, are anchored to the front hooks 14a through 14c located at the front side of the charging unit 3 to adjust a constant tensile (tractive) force of the coronal wires 11a through 11c. Then, as illustrated in FIG. 7, the terminals 12a′ through 12c′ that are provided at the other end of the discharge wires 11a through 11c, respectively, are hooked to the rear hooks 15a through 15c located at the rear side of the charging unit 3.

When hooking each terminal 12 of a discharge wire 11 to a corresponding hook position 13, the user passes the discharge wire 11 to the corresponding hook position 13 while grabbing the wire holder 10. By so doing, the discharge wire 11 can be anchored to the charging unit 3 without contacting the discharge wire 11. As described above, the wire retaining position on the wire holder 10 is substantially same as the wire retaining position on the charging unit 3, and therefore there is no need to forcibly move the terminal 12 and the terminal 12 can be passed to the hook position 13 smoothly.

After the discharge wire 11 has been hooked and anchored to the charging unit 3, as illustrated in FIG. 6, the user warps the front part wire retaining member 10F in the direction A and the rear part wire retaining member 10R in the direction B to release the contact pressure against each terminal 12 so that the wire holder 10 can be removed (separated) from the discharge wire 11. Accordingly, the anchoring of the discharge wire 11 to the charging unit 3 completes.

According to the above-described configuration, a user or operator does not contact discharge wires in replacement of the discharge wires, thereby preventing damage of the discharge wires due to tangle with other adjacent discharge wires and contact with other members or components in the image forming apparatus 1 and enabling easy anchoring of the discharge wires to the charging unit 3. Further, after the discharge wires 11 are anchored to the charging unit 3, the wire holder 10 is separated from the discharge wires 11, and therefore the discharge wires 11 can be replaced and anchored to the charging unit 3 easily and shortly regardless of space in the charging unit 3 and the number of discharge wires 11 to be set. Furthermore, this action can reduce operation time of anchoring the discharge wires 11, which can enhance a reduction in CPP.

It is to be noted that, when anchoring or replacing the discharge wire 11 in this embodiment, three discharge wires 11a through 11c are anchored together to the charging unit 3. However, the number of discharge wires to be anchored or replaced at one time is not limited thereto. For example, each single discharge wire can be anchored or replaced separately from the other discharge wires or two discharge wires can be anchored or replaced together at one time. With this action, a damaged or deteriorated discharge wire only can be replaced, thereby substantially enhancing durability of a discharge wire compared to replacement of a set of multiple discharge wires including non-damaged discharge wire(s) at one time.

The present invention may be characterized in that at least one discharge wire is retained to the wire holder so that at least one discharge wire is arranged to have a substantially same positional relation in the charging unit as the corresponding hook position of the charging unit. With this configuration, when attaching the discharge wire by using the wire holder, the terminal of the discharge wire can reach and anchor to the hook of the charging unit easily.

The present invention may be characterized in that the wire holder is flexible and elastic, and includes a plate member serving as a base member and wire retaining members integrally formed with the plate member, the wire retaining members disposed at both ends of the plate member in a longitudinal direction of the plate member. Each of the wire retaining members may retain either end of the discharge wire and be integrally formed together with the planar member. With this configuration, the discharge wire can be replaced without directly contacting the other discharge wires, and the wire holder can be separated from the discharge wire easily after the discharge wire has been anchored to the charging unit.

The present invention may be characterized in that the wire retaining members are warped toward the center of the wire holder in the longitudinal direction of the plate member of the wire holder before separating the wire holder from the discharge wire. By performing this action, the wire holder can be separated the wire holder from the discharge wire after the discharge wire is anchored to the charging unit.

The present invention may be characterized in that the wire retaining member is provided vertical to a longitudinal direction of the plate member at both ends of the plate member, and includes an extended wire retaining portion and a wire holder handle. The extended wire retaining portion extends outward from and beyond the surface of the plate member toward the anchoring portion to which the discharge wire is anchored to retain the end of the discharge wire. The wire holder handle extends from the end of the plate member outwardly in an opposite direction to the discharge wire retaining side. With this configuration, the discharge wire can be separated from the wire holder easily and grab the wire holder easily.

The present invention may be characterized in that the extended wire retaining portion includes a slit-like notch through which the discharge wire passes, and that the width of the slit-like notch is greater than the diameter of each of the discharge wire and is smaller than the cross-sectional diameter of each of the end of the discharge wire. According to this configuration, the extended wire retaining portion of the wire retaining member is bent toward the center of the wire holder in the longitudinal direction of the wire holder to pass the discharge wire through the slit-like notch and anchor the terminal of the discharge wire at the slit-like notch. Therefore, the discharge wire is tensioned by an elastic force of the wire holder and retained to the wire holder.

The present invention may be characterized by including a latching member to latch the end of the discharge wire to the hook disposed on the charging unit. With this configuration, the discharge wire can be anchored to the charging unit easily.

The above-described embodiments are illustrative and do not limit the present invention. Thus, numerous additional modifications and variations are possible in light of the above teachings. For example, elements at least one of features of different illustrative and exemplary embodiments herein may be combined with each other at least one of substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

What is claimed is:

1. A discharge wire anchoring mechanism includable in an image forming apparatus together with an image carrier and a charger including at least one replaceable discharge wire to uniformly charge a surface of the image carrier, the discharge wire anchoring mechanism comprising:
a wire holder to retain the at least one discharge wire with tension in preparation of anchoring the at least one discharge wire and separating from the at least one discharge wire after the at least one discharge wire is anchored to the charger.

2. The discharge wire anchoring mechanism according to claim 1, wherein the wire holder is made of resin material.

3. The discharge wire anchoring mechanism according to claim 1, wherein the at least one discharge wire is arranged to have a substantially same positional relation in the charger as a corresponding hook position of the charger.

4. The discharge wire anchoring mechanism according to claim 1, wherein the wire holder is flexible and elastic,
the wire holder includes
a plate-shaped base member; and
wire retaining members integrally formed with the plate-shaped base member, the wire retaining members disposed at both ends of the plate-shaped base member in a longitudinal direction thereof to retain both ends of the at least one discharge wire.

5. The discharge wire anchoring mechanism according to claim 4, wherein the wire holder is separated from the at least one discharge wire in a state in which the wire retaining members are warped toward the center of the wire holder in the longitudinal direction of the plate-shaped base member.

6. The discharge wire anchoring mechanism according to claim 4, the wire retaining members are disposed vertical to the longitudinal direction of the plate-shaped base member at both ends of the plate-shaped base member,
each of the wire retaining members includes
an extended portion extending outward from the surface of the plate-shaped base member toward a portion to which the at least one discharge wire is anchored, the wire retaining members retaining retain the end of the at least one discharge wire; and
a wire holder handle extending from either end of the plate-shaped base member outwardly to form an arc shape.

7. The discharge wire anchoring mechanism according to claim 6,
wherein the extended portion includes at least one notch through which each of the at least one discharge wire passes,
wherein a width of each of the at least one notch is greater than the diameter of each of the at least one discharge wire and smaller than the cross-sectional diameter of each of the end of the at least one discharge wire.

8. The discharge wire anchoring mechanism according to claim 4, further including a latching member to latch an end of the at least one discharge wire to a hook of the charger.

9. A charger includable in an image forming apparatus for uniformly charging a surface of an image carrier to form an image thereon, the charger comprising:
at least one discharge wire to be replaceable with a new one using a discharge wire anchoring mechanism,
wherein the discharge wire anchoring mechanism includes a wire holder to retain the at least one discharge wire with tension,
wherein the at least one discharge wire is anchored to the charger with the at least one discharge wire retained to the wire holder and then the wire holder detaches the at least one discharge wire.

10. The charger according to claim 9, wherein the discharge wire is either one of a tungsten wire and a metal plated tungsten wire.

11. The charger according to claim 9, further includes a hook to which an end of the at least one discharge wire is latched.

12. An image forming apparatus comprising;
an image carrier;
a charger to uniformly charge a surface of the image carrier to form an image thereon, the charger comprising at least one discharge wire to be replaceable with a new one using a discharge wire anchoring mechanism, the charger disposed detachably attachable to the image forming apparatus; and
a discharge wire anchoring mechanism comprising a wire holder to retain the at least one discharge wire with tension in preparation of anchoring the at least one discharge wire and separating from the at least one discharge wire after the at least one discharge wire is anchored to the charger,
wherein the discharge wire anchoring mechanism includes a wire holder to retain the at least one discharge wire with tension,
wherein the at least one discharge wire is anchored to the charger with the at least one discharge wire retained to the wire holder and then the wire holder detaches the at least one discharge wire.
